(19) United States
(12) Patent Application Publication
(10) Pub. No.: US 2015/0347563 A1
(43) Pub. Date: Dec. 3, 2015

(54) INFORMATION PROVIDING APPARATUS

(71) Applicant: DENSO CORPORATION, Kariya-city (JP)

(72) Inventors: YUUSUKE KATAYAMA, Toyota-city (JP); YUUYA HATTORI, Iwakura-city (JP); YUSUKE MIZUNO, Anjo-city (JP); HIDEYUKI SUGIURA, Obu-city (JP)

(21) Appl. No.: 14/715,930

(22) Filed: May 19, 2015

(30) Foreign Application Priority Data
May 30, 2014 (JP) 2014-112899

(51) Int. Cl. G06F 17/30

(52) U.S. Cl. CPC G06F 17/30598; G06F 17/30569

(57) ABSTRACT

An information providing apparatus providing an information item to a user includes a generated information obtaining portion, a category determination portion, a priority setting portion, a selection portion, and a providing portion. The generated information obtaining portion obtains generated information items that are generated by executions of multiple applications, respectively. The category determination portion determines a category of each of the generated information items. The priority setting portion sets a priority order based on the category of each of the generated information items. The selection portion selects a providing information item to be provided from the generated information items obtained by the generated information obtaining portion according to the priority order. The providing portion provides the selected providing information item to the user.

### CROSS REFERENCE TO RELATED APPLICATION

This application is based on Japanese Patent Application No. 2014-112899 filed on May 30, 2014, the disclosure of which is incorporated herein by reference.

### TECHNICAL FIELD

The present disclosure relates to an information providing apparatus that provides information to a user.

### BACKGROUND

Patent literature 1: JP H10-104004 A2 (corresponding to U.S. Pat. No. 6,208,932 B1)

Conventionally, an information providing apparatus is known (for example, referring to patent literature 1). The information providing apparatus allocates a priority order and a rank to multiple input information items according to a type of information. The information providing apparatus provides information from among the one or more information items having predetermined rank values in the decreasing order of the priority when information is presented.

The inventors of the present application have found that a setting of priority in the information providing apparatus may be difficult when a content source is added and information may be provided excessively or deficiently since it is not considered that a content source for performing an application is newly added. For example, a design principle of an existing content source may mismatch a design principle of a new content source. Information may be provided in a priority that is unfavorable for a user. A provision of information that should be notified as quickly as possible may be delayed. Information having a low urgency may be provided preferentially.

### SUMMARY

It is an object of the present disclosure to provide an information providing apparatus that provides information to a user. The information providing apparatus enables to provide information suitably when the user adds a new content source.

According to one aspect of the present disclosure, an information providing apparatus providing an information item to a user is provided. The information providing apparatus includes a generated information obtaining portion, a category determination portion, a priority setting portion, a selection portion, and a providing portion. The generated information obtaining portion obtains generated information items that are generated by executions of multiple applications, respectively. The category determination portion determines a category of each of the generated information items. The priority setting portion sets a priority order based on the category of each of the generated information items. The selection portion selects a providing information item to be provided from the generated information items obtained by the generated information obtaining portion according to the priority order. The providing portion provides the selected providing information item to the user.

According to the information providing apparatus, since the priority order is set based on the category data included in the generated information and the providing information is selected according to the priority order, it may be possible to rank information items suitably even when an application is added. It may be possible to provide an information items in just proportion. Thus, it may be possible to provide information suitably when the user adds a new content source.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram schematically illustrating an information providing apparatus in embodiments;

FIG. 2 is a flowchart illustrating an information providing processing executed by a CPU of a controller in the embodiments;

FIG. 3 is a diagram illustrating a map expressing a category and an evaluation standard in the first embodiment;

FIG. 4A is a diagram illustrating a map expressing priority order between categories in a center display in the first embodiment;

FIG. 4B is a diagram illustrating a map expressing a priority order between categories in a head up display in the first embodiment;

FIG. 5 is a diagram illustrating a table expressing a category and an evaluation standard in the second embodiment;

FIG. 6 is a block diagram schematically illustrating the information providing apparatus in the second embodiment;

FIG. 7 is a flowchart illustrating an information providing processing executed by a CPU of a controller in the second embodiment;

FIG. 8 is a diagram illustrating a table expressing a priority order between categories in the second embodiment;

FIG. 9A is a diagram illustrating a center display in an first example displaying generated information;

FIG. 9B is a diagram illustrating a head up display in the first example displaying the generated information;

FIG. 9C is a diagram illustrating the center display in a second example displaying generated information; and

FIG. 9D is a diagram illustrating the head up display in the second example displaying generated information.

### DETAILED DESCRIPTION

Embodiments will be explained with referring to the drawings.

### First Embodiment

A configuration of the first embodiment will be explained.

An information providing apparatus 1 is mounted to a vehicle such as a passenger vehicle. The information providing apparatus 1 selects providing information that is actually provided from among generated information generated by an execution of multiple applications. The information providing apparatus 1 provides the selected providing information to a user. Incidentally, information may be also referred to as an information item.

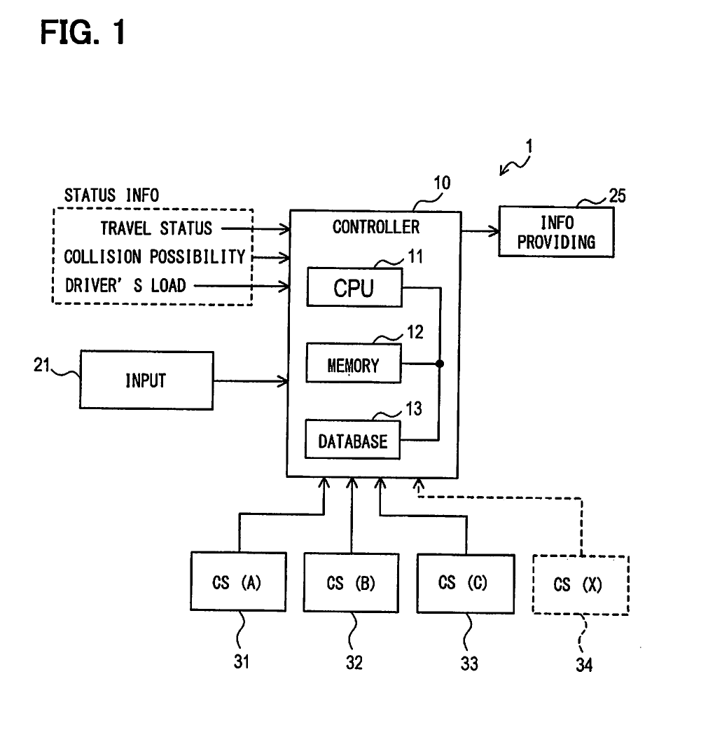

The information providing apparatus 1 includes a controller 10, an input portion 21, and an information providing portion 25 as described in FIG. 1. The input portion 21 includes, for example, a well-known user interface such as a toggle switch and a touch panel. The input portion 21 transmits a message that a user performs an operation instruction to the controller 10.

The information providing portion 25 corresponds to a display device such as a head up display and a liquid crystal display. Incidentally, the liquid crystal display includes a center display of a vehicle. The information providing portion 25 displays an image according to an image signal (also referred to as a video signal) generated by the controller 10.

The controller 10 includes a computer having a CPU 11 and a memory 12 such as a ROM and a RAM. The CPU 11 executes a program stored in the memory 12, and performs various processing including information providing processing or the like

The controller 10 receives status information and various data from content sources 31-33. The status information corresponds to, for example, a travelling status (for example, a vehicle speed, and a steering angle) of a subject vehicle, a collision possibility (including a determination whether a collision occurs or not) to an object around the subject vehicle, and a driver's load (for example, a travelling time, an average travelling speed). Each of the content sources 31-33 generates information (hereinafter, referred to as generated information). The controller 10 obtains the generated information.

Incidentally, the subject vehicle means a vehicle that the information providing apparatus 1 is mounted to.

The content sources 31-33 correspond to a device that executes an application and provides information regarding a vehicle. For example, the content sources 31-33 correspond to a navigation device, an engine control device, a brake control device, and an electric window control device, or the like.

The content sources 31-33 are mounted to the vehicle in advance. The content sources 31-33 are configured, when the generated information is generated, the generated information includes information for specifying which content source. The controller 10 determines a category of information based on information for specifying a content source.

In the information providing apparatus 1, a content source can be added. For example, it is supposed that a content source 34 described in FIG. 1 is added. In this case, the controller 10 determines a category according to a condition whether identification information (ID) is included in generated information that is generated by the content source 34. Incidentally, the identification information (ID) is set according to a type of a vehicle.

It is supposed that a vehicle developer recognizes that a newly added content source suits a vehicle (or a vehicle type). In this case, an identification information (ID) set according to the vehicle type is notified of a developer of the newly added content source, the developer produces an application, and the identification information is added to the generated information. However, when the vehicle developer does not recognize the content source, generated information without identification information is transmitted to the controller 10.

The controller 10 determines a category according to an existence/non-existence of the identification information (or an identification result) regarding the newly added content source 34. The controller 10 determines a category according to a condition whether the identification information regarding the newly added content source 34 is appropriate or not.

The controller 10 includes a database 13. The database 13 stores a map for classifying input generated information into one of multiple categories, a map for illustrating that in which priority order the generated information classified into each category is provided to a user.

(Processing in the First Embodiment)

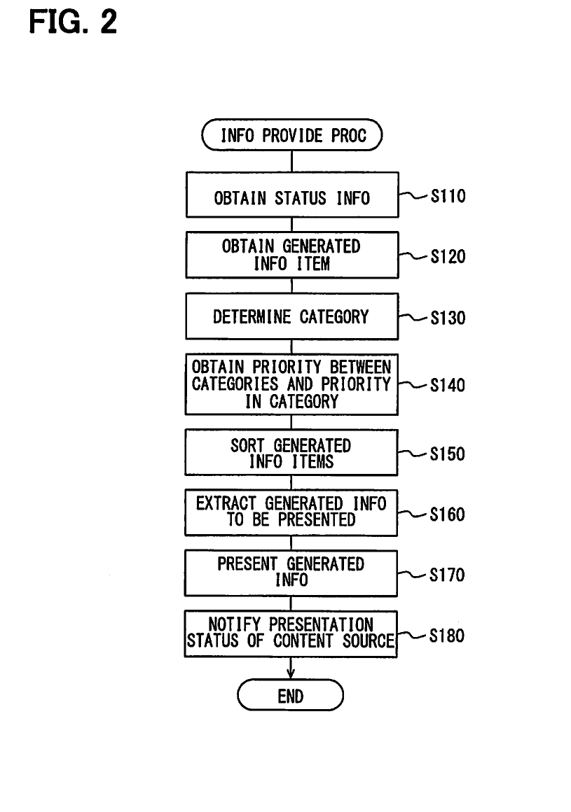

The controller 10 in the information providing apparatus 1 performs information providing processing described in FIG. 2. The information providing processing is initiated when, for example, the information providing apparatus 1 is supplied with power. And then, the information providing processing is performed repeatedly in each fixed period.

The information providing processing obtains status information initially at S110 as described in FIG. 2. The status information includes the travelling status of the subject vehicle, the collision possibility with the object around the subject vehicle, and the driver's load, as mentioned above.

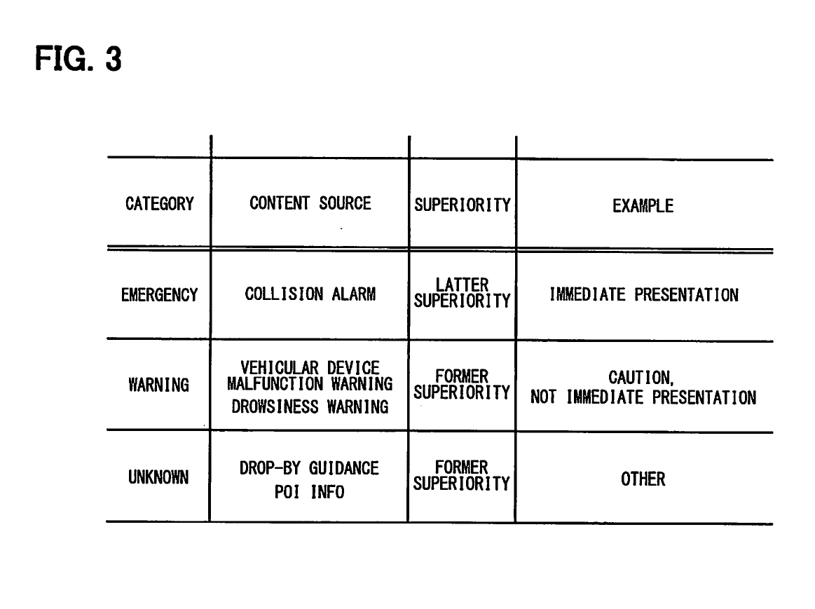

At S120, the generated information (or data) is obtained from each of the content sources 31-33. At S130, a category is determined based on the generated information. Incidentally, the category includes three types: an emergency, a warning, and an unknown. The database 13 includes the categories and correlates the categories, the content sources, and superiorities in the identical category as described in FIG. 3. The superiorities in the identical category may also be referred to as a priority in a category.

Incidentally, FIG. 3 describes examples of use.

The category of the emergency corresponds to a collision alarm or the like and is correlated with a content source regarding an accident in a near future. When multiple generated information items corresponding to the category of the emergency exist, the superiority in the identical category (in this case, the category of the emergency) is set as follows. The generated information obtained in the latter has priority over the generated information item obtained in the former. This superiority rule may be referred to a latter superiority. This superiority rule is set based on an idea that all information being urgent should be displayed even when a part of the all information with emergency is displayed only for a short time.

The category of the warning corresponds to the content source regarding an event that may influence a travelling of a vehicle. For example, the content source in the category of the warning corresponds to a malfunction warning of a vehicular device and a warning to drowsiness of a driver. When multiple generated information corresponding to the category of the warning exist, superiority in the identical category is determined as follows. A generated information item obtained in the former has priority over a generated information item obtained in latter. This superiority rule may be referred to a former superiority. This superiority rule is set based on an idea that, regarding the information corresponding to the category of the warning, an event displayed in the former should be solved initially and the information may be displayed subsequently.

The category of the unknown corresponds to the content source regarding comfort for the user. For example, the content source in the category of the unknown corresponds to drop-by information and a point-of-interest (POI). When multiple generated information items corresponding to the category of the unknown exist, superiority in the identical category is determined as follows. Generated information obtained in former has priority over a generated information item obtained in latter. Thus, the former superiority is set regarding the superiority in the identical category.

Incidentally, regarding the added content source 34, when there is no identification information or generated information generated by the content source 34 does not include identification information (or in a case where an identification has been failed), the added content source 34 is classified into the category of the unknown. When there is the identification information, the added content source 34 is classified into the category of the warning. That is, the added content source 34 is not classified into the category of the emergency. It may be possible to prevent information being urgent from not being notified due to the added content source 34. It may be possible that information being urgent is notified even when the content source 34 is added.

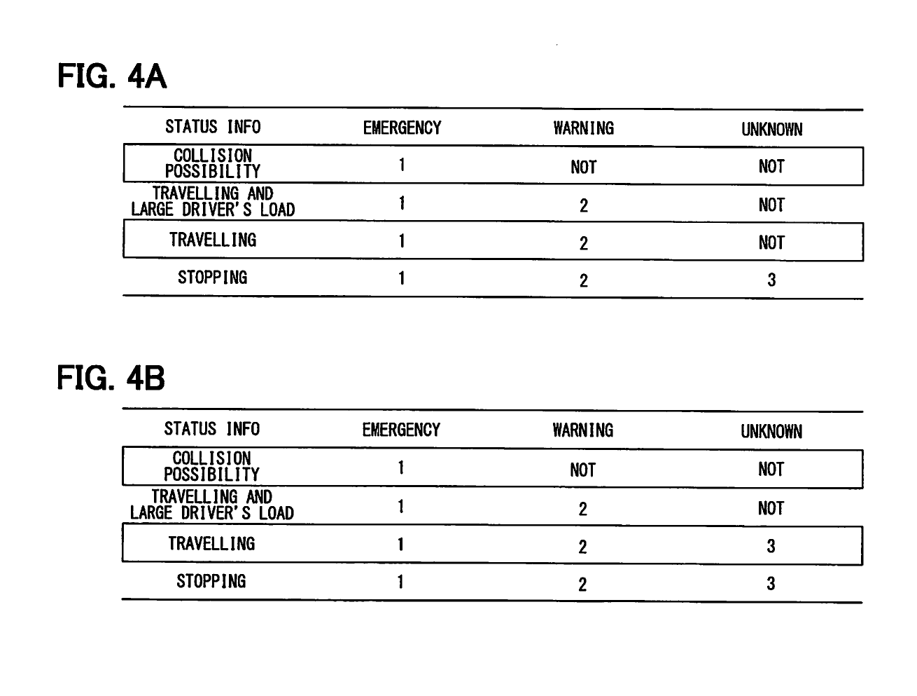

At S140, a priority order between categories and a priority order in a category are obtained. The priority order between categories is set according to the status information as described in FIG. 4A and FIG. 4B.

The priority order between categories may be set differently according to a mode of the information providing portion 25. For example, FIG. 4A represents a configuration at the time a center display displays information. FIG. 4B represents a configuration at the time a head up display displays information.

The configurations represent a category provided according to the status information obtained at S110, and a priority order between the categories. Specifically, based on the status information, a status of the subject vehicle is classified into either of (i) a status of a collision possibility, (ii) a status of a travelling and large driver's load, (iii) a status of a travelling, and (iv) a status of a stopping. The status of the collision possibility corresponds to a case where a possibility of a collision with an object is relatively high. The status of the travelling and large driver's load corresponds to a case where the subject vehicle is travelling and a load on the driver is large.

In a case of the status of the collision possibility, the configuration at the time the center display displays information and the configuration at the time the head up display displays information are determined as follows. Only the category of the emergency is displayed, the category of the warning and the category of the unknown are not displayed (referring to FIG. 4A and FIG. 4B). Incidentally, FIG. 4A represents a standard of the priority order between categories for the center display, and FIG. 4B represents a standard of the priority order between categories for the head up display.

In a case of the status of the travelling and large drivers load, the priority order between the categories is set in the order of the category of the emergency and the category of the warning when the center display displays information and when the head up display displays the information. In this case, the category of the unknown is not displayed. In a case of the status of the stopping, the priority order between the categories are set in the order of the category of the emergency, the category of the warning, and the category of the unknown. Incidentally, the priority order between the categories represents that the category of the emergency has a first priority over the category of the warning and the category of the unknown.

In a case of the status of the travelling, the priority order between the categories is set in the order of the category of the emergency and the category of the warning when the center display displays information. In this case, the category of the unknown is not displayed. In a case of the status of the travelling, the priority order between the categories is set in the order of the category of the emergency, the category of the warning, and the category of the unknown when the head up display displays information.

According to the above configuration, the priority order between categories is set. The priority order in a category is set according to the priority order in the identical category described in FIG. 3.

At S150, the generated information (data) is sorted according to the priority order between the categories and the priority order in a category. The generated information to be presented is extracted at S160. At S160, generated information having the first priority is extracted.

At S170, an image signal is generated based on the extracted generated information and the image signal is transmitted to the information providing portion 25. At S180, information indicating whether information corresponding to the generated information provided by each of the content source 31-34 has been presented to a user is generated. And then, the information generated at S180 is notified of each of the content sources 31-34.

At S180, for example, when an alert based on generated information provided by the content source 31 is performed, the content source 31 receives information indicating that the alert has been presented. When an alert or a caution based on the generated information provided by the content source 31 is not performed, the content source 31 receives information indicating that the alert or the caution has not been presented. After transmitting the information to the content source 31, the information providing processing ends.

The controller 10 in the information providing apparatus 1 obtains the generated information that is generated by an execution of multiple applications, and recognizes a category of the obtained generated information using a category data included in the generated information. The controller 10 sets the priority order based on a category of the generated information, selects providing information to be presented among the obtained generated information according to the priority order, and provides the selected providing information to a user.

According to the information providing apparatus 1, since the priority order is set based on the category data included in the generated information, it may be possible to rank information suitably even when an application is added.

The controller 10 in the information providing apparatus 1 obtains the status of the information providing apparatus and selects providing information according to the category and the status.

According to the information providing apparatus 1, it may be possible to change providing information to be provided according to the status of the information providing apparatus. Thus, it may be possible to provide more appropriate information.

The information providing apparatus 1 is mounted to a vehicle. The controller 10 obtains a behavior of the subject vehicle as the status of the information providing apparatus.

According to the information providing apparatus 1, it may be possible to change providing information according to the behavior of the subject vehicle.

The controller 10 in the information providing apparatus 1 obtains a status of a driver of the subject vehicle as the status of the information providing apparatus.

According to the information providing apparatus 1, it may be possible to change the providing information according to the status of the driver of the subject vehicle.

The controller 10 includes identification information as a category data in the generated information and determines the category based on propriety of the identification information.

According to the information providing apparatus 1, since a category is determined based on the propriety of the identification information, it may be possible to change the providing information according to a condition whether the generated information item includes identification information.

### Second Embodiment

(Configuration and Processing in the Second Embodiment)

An information providing apparatus 2 in a second embodiment will be explained. A portion different from the information providing apparatus 1 in the first embodiment will be explained in the second embodiment. A portion similar to the information providing apparatus 1 in the first embodiment will not be explained.

In the first embodiment, a category is determined according to the type of data and the existence of the identification information at S130 and S140. In the second embodiment, a category may be determined by an application programming interface (API). The API represents a transfer format of a data.

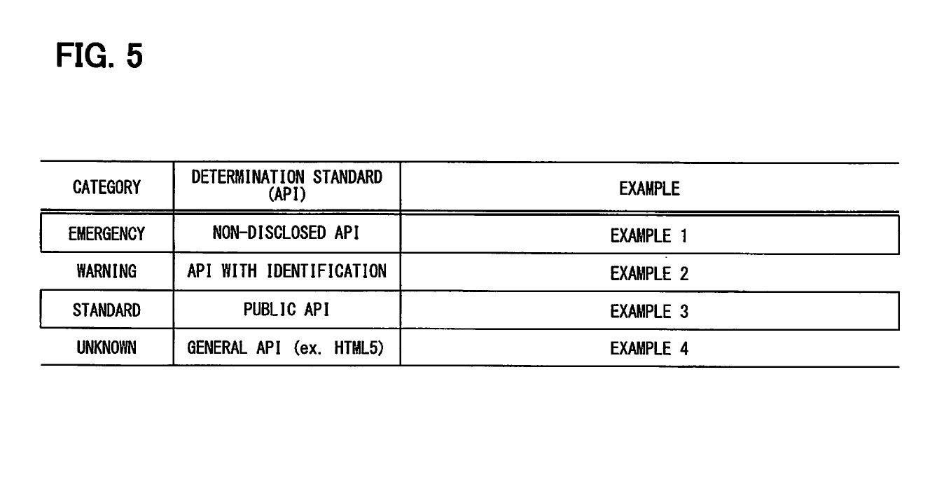

Specifically, when the category is determined at S130, the category is determined based on a format of the API, which transfers generated information. In the present embodiment, for example, as described in FIG. 5, in addition to the three types of categories (the emergency, the warning, and the unknown), a category of a standard is prepared. Examples in FIG. 5 are as follows. The first example corresponds to emergency information for assuring secure, and the emergency information is presented immediately. The second example corresponds to caution information, and the caution information is not necessary to be presented immediately. The third example corresponds to a content source corresponding to a public API, which is designed to be information controlled. The fourth example corresponds to a content source of a general web application or a general web page configuration. The fourth example may be realized by preparing a browser-like wrapper tool.

The category of the emergency is correlated with a non-disclosed API. It is intended that only a vehicle developer uses a non-disclosed API and an added content source cannot use the non-disclosed API.

The category of the warning correlates with an API with an identification. Some kinds of identification are performed in the API with identification. The category of the standard is correlated with a public API. Incidentally, the public API receives a control or a limitation in an API level not to prevent a case where an information presentation performed in a vehicle travelling causes excessive information or not to prevent the information presentation from travelling. Thus, the public API is designed so that a certain level of safety will be assured by satisfying the control or the limitation. For example, a data satisfying the control or the limitation is set so that a limitation of the number of characters, a type of font, color, and arrangement are included within a prescribed range.

The category of the unknown corresponds to a content group such as a general web application and a general web page. Regarding the content group, a wrapper function 14 converts generated information. The converted generated information is received and transmitted through an prescribed exclusive API. The exclusive API receives the converted generated information as the category of the unknown. The content group including the general web application and the web page does not consider an application to the information providing apparatus 2. More specifically, the content group described in, for example, HTML5 may be used in the information providing apparatus 2. Although the category of the unknown can display anything, a situation enabling to display data is limited. For example, the category of the unknown may be displayed only during stopping of a vehicle.

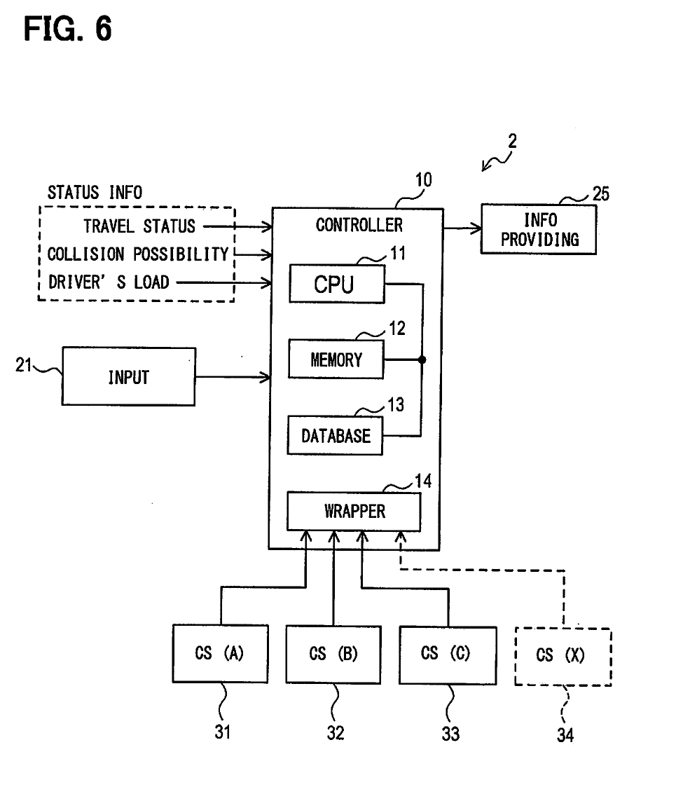

The information providing apparatus 2 in the second embodiment includes the wrapper function 14 that converts information obtained from the content sources 31-34 to a format corresponding to the information providing apparatus 2 as described in FIG. 6. The wrapper function 14 includes a browsing function and a conversion function when a content source has URL of contents as information, for example. The browsing function obtains HTML from the URL. The conversion function converts the obtained HTML to a generated information format that corresponds to a format that enables to input by an API. An API call performed after conversion by the wrapper function 14 is set in advance to be handled as the category of the unknown.

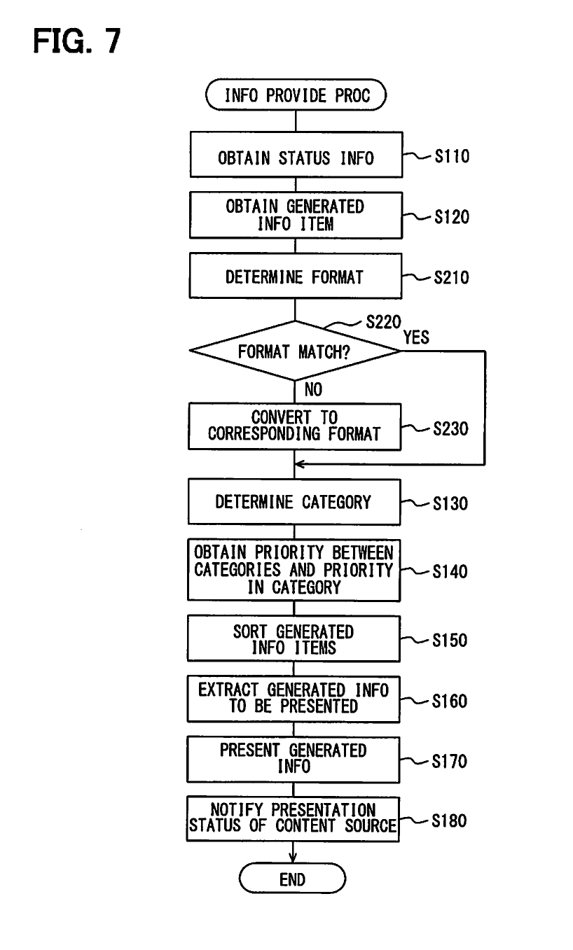

The wrapper function 14 is executed as a part of processing performed by the CPU 11. As described in FIG. 7, after processing of S120, a format of the obtained generated information is determined at S210. When the format of the obtained generated information corresponds to a format of the information providing apparatus 2 (S220: YES), the processing shifts to S130.

It is determined whether the format of the obtained generated information corresponds to the information providing apparatus 2. When the format of the obtained generated information does not correspond to the format of the information providing apparatus 2 (S220: NO), the format of the obtained generated information is converted to a format corresponding to the information providing apparatus 2 at S230. The processing shifts to S130.

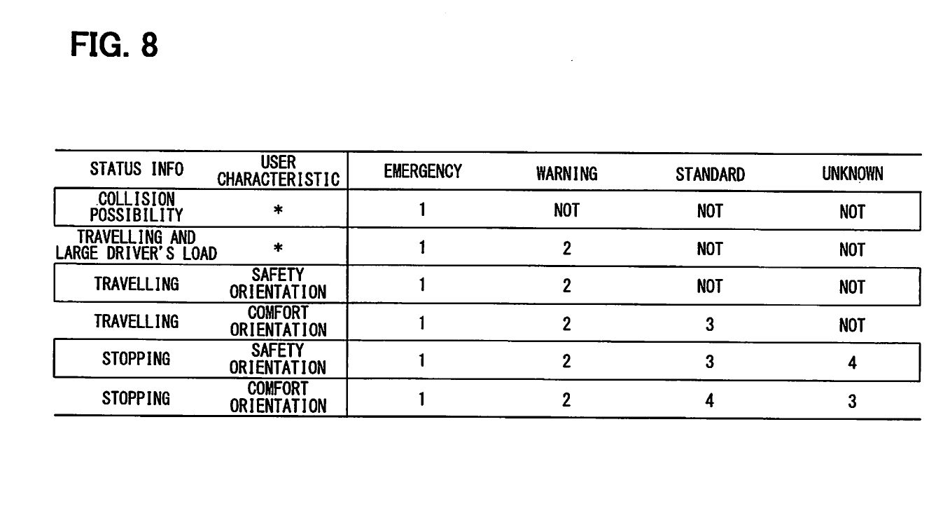

In the processing at S140 in the present embodiment, when an order between the categories is determined, a map described in FIG. 8 may be used. According to the map described in FIG. 8, contents or a priority order of generated information to be presented is determined with considering a user characteristic when the status information corresponds to the travelling or the stopping.

Incidentally, the user characteristic represents a taste and a behavior pattern of the user. In the present embodiment, the user characteristic includes two types as an example. The two type of the user characteristic correspond to a safety orientation and a comfort orientation. An orientation of the user may be set by a setting beforehand performed by the user through the input portion 21 or may be set by learning a driving status of the driver. When the safety orientation is set, minimum amount of information is provided during travelling of a subject vehicle, and more simple information is provided prior to other information during stopping the subject vehicle.

When the comfort orientation is set, more information is provided during the travelling of the subject vehicle and more rich contents is provided during the stopping of the subject vehicle. Specifically, in an example described in FIG. 8, according to the user characteristic of the safety orientation or the comfort orientation, the order of the category of the standard and the order of the category of the unknown are switched.

That is, by changing information displayed on the information providing portion 25 according to the user characteristic, it may be possible that the information suitable for the user is provided.

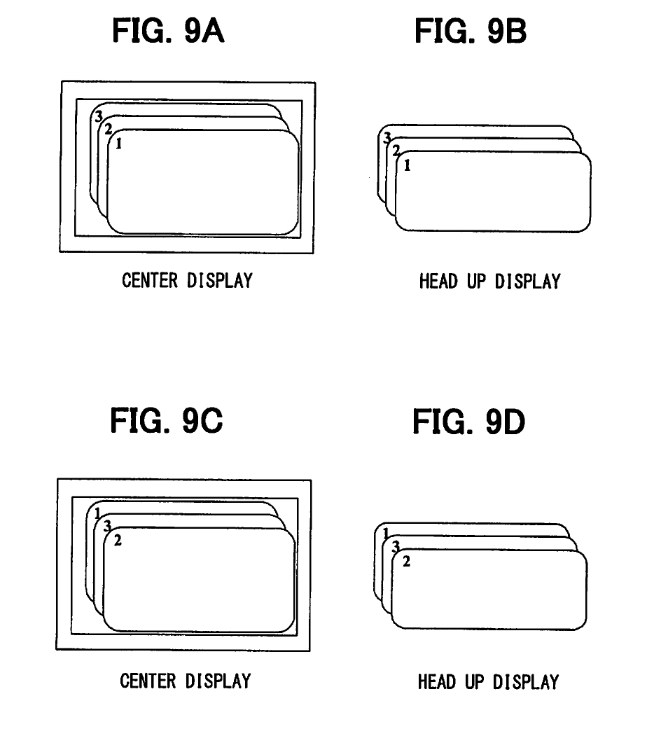

When the information providing portion 25 displays the generated information, since any type of display manner may be used, the generated information is displayed hierarchically according to the priority order, which is set at S140 as described in FIG. 9A and FIG. 9B.

That is, generated information having the highest priority order is displayed on the top layer, so that this display manner attracts attention of a user. When the user operates the input portion 21 such as a toggle switch, the generated information to be presented changes as described in FIG. 9C and FIG. 9D. Accordingly, it may be possible to provide more information to the user.

In this configuration, it is supposed that a generated information having a higher priority order than the generated information that is displayed is newly obtained. The generated information having the highest priority order may be displayed on the top layer.

In the information providing apparatus 2, the generated information includes format information regarding a transfer format as a category data. The transfer format represents a format at the time when the data is transferred. The controller 10 determines the category based on the format information.

According to the information providing apparatus 2, since the format information regarding the transfer format is included, it may be possible that the information providing apparatus 2 determines the category based on the format information. Therefore, it may be possible to simplify processing in a determination of the category by the controller 10.

The controller 10 in the information providing apparatus 2 includes API as the format information.

In this case, it may be possible that the information providing apparatus 2 determines the category with the API.

The controller 10 determines whether each application generating the format information matches the transfer format corresponding to the information providing apparatus based on the format information. The controller 10 converts the generated information input from an application which does not match the transfer format to the generated information having the transfer format corresponding to the information providing apparatus.

According to the information providing apparatus 2, it may be possible to convert a data that is mismatched with a transfer format corresponding to the information providing apparatus to a transfer format corresponding to the information providing apparatus.

### Other Embodiment

The controller 10 in the embodiments classifies the category based on the contents of the generated information and the API at S130 and S140. The controller 10 may determine the category using an extracted data, which is obtained by extracting a part of the generated information. For example, the category may be classified based on a summary of the generated information or a keyword included in the generated information. When the generated information includes an image, the image may be processed by an image processing, an object included in the image may be specified, and a category according to a type of the object may be classified.

According to the information providing apparatus, it may be possible to determine a category according to a type of a data, a keyword included in the generated information, and a summary of the generated information or the like.

As a use of the information providing apparatus 1, 2, it is considered that the information providing apparatus automatically determines a category and provides content information in an appropriate priority order when a user operates the information providing apparatus and adds a new arbitrary content source, for example. It should be noted that the use of the information providing apparatus is not limited this case. For example, the information providing apparatus may be used for a system upgrade by a developer or the like.

The information providing processing performed by the information providing apparatus 1, 2 may be unnecessary to rank all registered content sources 31-34. The information providing processing may rank regarding only content source outputting a request of information output at a certain time point.

The information providing apparatus 1, 2 perform the information providing processing at a vehicle. However, the information providing processing may be realized on a server, a cloud service, or the like and may be provided to the inside of the vehicle through communication.

The time when the information providing apparatus 1, 2 determine a category may unnecessarily correspond to the time when a new content source is added. For example, the time when the information providing apparatus determines a category may correspond to the time when a content source requires information output. Incidentally, a category may be linked to a content source, and a category may be liked to each display content item of a content.

The information providing apparatus 2 uses the API in determining a category. Instead of the API, a category may be determined whether a certain content source has already been registered to a server or by a type of a content source, through communication with a management server. A category may be determined by a result of a content summary (a sentence summary, or image recognition) of the generated information.

The information providing apparatus 2 uses the wrapper function 14 to all content sources. A content source in which a conversion is unnecessary may not pass through the wrapper function 14, and the wrapper function 14 may be set to only a content source in which a conversion is required.

The processing at S110 of the processing executed by the controller 10 may correspond to a status obtaining portion. The processing at S120 may correspond to a generated information obtaining portion. The processing at S130 may correspond to a category determination portion, and the processing at S140 and S150 may correspond to a priority setting portion.

The processing at S160 may correspond to a selection portion, and the processing at S170 may correspond to a providing portion. The processing at S210 and S220 may correspond to a format determination portion, and the processing at S230 may correspond to a conversion portion.

It is noted that a flowchart or a processing of the flowchart in the present application includes steps (also referred to as sections), each of which is represented, for example, as S110. Further, each step may be divided into several sub-sections, and several sections may be combined into a single section.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An information providing apparatus providing an information item to a user, the information providing apparatus comprising:
a generated information obtaining portion obtaining generated information items that are generated by execution of a plurality of applications;
a category determination portion determining a category of each of the generated information items;
a priority setting portion setting a priority order based on the category of each of the generated information items;
a selection portion selecting a providing information item to be provided from the generated information items obtained by the generated information obtaining portion according to the priority order; and
a providing portion providing the selected providing information item to the user.

2. The information providing apparatus according to claim 1, further comprising:
a status obtaining portion obtaining a status of the information providing apparatus, wherein
the priority setting portion selects the providing information item according to the category and the status of the information providing apparatus.

3. The information providing apparatus according to claim 2, wherein
the information providing apparatus is provided to a subject vehicle, and
the status obtaining portion obtains a behavior of the subject vehicle as the status of the information providing apparatus.

4. The information providing apparatus according to claim 2, wherein
the information providing apparatus is provided to a subject vehicle, and
the status obtaining portion obtains a condition of a driver of the subject vehicle as the status of the information providing apparatus.

5. The information providing apparatus according to claim 2, wherein
the status obtaining portion obtains a characteristic of the user as the status of the information providing apparatus.

6. The information providing apparatus according to claim 1, wherein:
a generated information item includes a format information item regarding a transfer format, which indicates a format at a time when a data is transferred; and
the category determination portion determines the category based on the format information item.

7. The information providing apparatus according to claim 6, wherein
the format information item includes an application programming interface.

8. The information providing apparatus according to claim 1, wherein
a generated information item includes an identification information item, and
the category determination portion determines a category of the generated information item based on whether the identification information item is proper or not.

9. The information providing apparatus according to claim 1, wherein
the category determination portion determines the category based on an extraction data, and
the extraction data corresponds to a part of a generated information item and is obtained by being extracted from the generated information item.

10. The information providing apparatus according to claim 6, further comprising:
a format determination portion determining, based on the format information item, whether each of the applications that generates the format information item matches a transfer format corresponding to the information providing apparatus; and
a conversion portion converting a generated information item obtained from an application that does not match the transfer format to the transfer format corresponding to the information providing apparatus.
